(19) United States
(12) Patent Application Publication
(10) Pub. No.: US 2004/0024680 A1
(43) Pub. Date: Feb. 5, 2004

(54) Method of doing business

(76) Inventor: Alexander Joseph - Robert Schizas JR., N. Charleston, SC (US)

Correspondence Address: ALEXANDER J.R. SCHIZAS, 2130 Thompson Ave, PIER T, N. CHARLESTON, SC, 29405, US

(21) Appl. No.: 09/818,749

(22) Filed: Jun. 1, 2001

(51) Int. Cl. G06F 17/60

(52) U.S. Cl. 705/37; 705/26

(57) ABSTRACT

Whereas the technical revolution surrounding the use of the internet as a trading medium has not to date, included the use of the internet for the trading of the commodity known as Liquefied Natural Gas (LNG) in either the physical commodity form, nor as futures and options trading of Liquefied Natural Gas (LNG), I believe that this business method should be protected.

I believe that the utilization of an internet based electronic exchange utilized for the purposes of trading the physical commodity known as LNG and futures and options contracts of LNG will serve to enhance the liquidity in the market fueling the growth of this environmentally sound feedstock for power generation the world over.

### METHOD OF DOING BUSINESS UTILITY PATENT APPLICATION STATEMENT

Where all men are present, let it be know that on this the 27^{th} day of March in the year of our Lord 2001, Alexander J. R. Schizas is submiting this statement as an attachment to a Utility Patent Application under the METHOD OF DOING BUSINESS criteria.

“The electronic trading of the commodity known as Liquefied Natural Gas (LNG) via the internet of both the physical commodity known as Liquefied Natural Gas (LNG) and futures and options contracts of Liquefied Natural Gas (LNG)”

Thereby claim under business method criteria the utility patent rights under the business method criteria the following:

1) The electronic trading of the commodity known as Liquefied Natural Gas (LNG) via the internet of both the physical commodity known as Liquefied Natural Gas (LNG) and futures and options contracts of Liquefied Natural Gas
